(19) United States
(12) Patent Application Publication
(10) Pub. No.: US 2002/0042758 A1
(43) Pub. Date: Apr. 11, 2002

(54) Method and system for ordering and downloading digital content with unique identity recognition through a network

(76) Inventor: Jyh-Yuan Deng, Shulin City (TW)

Correspondence Address: RABIN & CHAMPAGNE, PC, 1101 14TH STREET, NW, SUITE 500, WASHINGTON, DC, 20005, US

(21) Appl. No.: 09/972,804

(22) Filed: Oct. 9, 2001

(30) Foreign Application Priority Data
Oct. 6, 2000 (TW) 89120968

(51) Int. Cl. G06F 17/60

(52) U.S. Cl. 705/26

(57) ABSTRACT

A system for ordering and downloading digital content with unique identity recognition through a network is provided. The system includes a user terminal, a web store, and a digital right management (DRM) server. The web store is used for providing a digital content product for purchase at the user terminal. The DRM server is capable of connecting to the web store and is employed for providing a unique identity (UID) for the user terminal to apply for, and the digital content product for the user terminal to download. In addition, the DRM server performs UID recognition for the user terminal so as to allow the user terminal to download the digital content product from the DRM server. When the user opens and uses the digital content product, the user is required to use only a UID. Thus, when the user have purchased many digital content products, it is unnecessary for the user to remember which of the identities obtained by different web stores is associated with the digital content product to be opened. In this way, the user can use the digital content product more conveniently.

This application incorporates by reference Taiwanese application Serial No. 89120968, filed on Oct. 6, 2000.

### BACKGROUND OF THE INVENTION

1. Field of the Invention

The invention relates in general to a method and system for ordering and downloading digital content in a network, and more particularly to a method and system for ordering and downloading digital content with unique identity recognition through a network.

2. Description of the Related Art

Nowadays, computers and networks are not only used to transfer and share information, but also used for doing business. In this way, consumption behavior of consumers is changing gradually. Before computer networks, such as the Internet, are widely used for business, consumers have to come to the stores to choose desired products and pay the money by cash or credit card. Now, an electronic commerce (e-commerce) system such as an web store is capable of providing on-line shopping and ordering for users to buy their desired products, such as books, or computer peripherals, by way of computers connecting to the Internet. After the users finished some processes of purchase of products, the web store delivers the products for the users. In addition, the consumers can purchase digital content by way of e-commerce systems. Such digital content as electronic-book (e-book), digital music, e.g. digital audio file in Moving Picture Experts Group audio layer 3 (MP3) format, or application program systems can be purchased through e-commerce systems. Once the consumers complete some purchase processes, they can obtain copies of the digital content for use by downloading such type of digital content. For both the consumers and businesses, the transactions are convenient and fast.

Referring to FIG. 1, it illustrates a user connecting to a plurality of web store through the Internet. In FIG. 1, a user terminal 105 connects to web stores 101, 102, 103, and 104 through the Internet. When a user registers at one web store, the web store is to assign an identity (ID) to the user. Afterwards, the user may login onto the web store so as to purchase digital content in the web store. As shown in FIG. 1, a user U1 at user terminal 105 logins onto web stores 101, 102, 103, and 104 by using identity ID1, ID2, ID3, and ID4 respectively. Moreover, for the sake of network transmission security and copyright, the web stores encrypt the digital content by using a key which is associated with the ID of a registered user before allowing the registered user to download the digital content. For instance, user U1 at user terminal 105 purchases an e-book ebook1. Then, user U1 is allowed to download the e-book ebook1 after the e-book ebook1 is encrypted by web store 101 with using a key associated with the identity ID1 of user U1. In order to read the e-book ebook1, user U1 must be identified as the registered user with ID1. Similarly, if user U1 purchases another e-book ebook2 in web store 102, user U1 must be identified as the registered user with ID2 so as to read the e-book ebook2. Thus, user U1 has to remember many identities associated with different digital content products, and to remember where the e-books are purchased so as to use the correct identities properly. In this way, for the users, this requirement of remembering many identities brings the users great inconvenience.

### SUMMARY OF THE INVENTION

It is therefore an object of the invention to provide a method and system for ordering and downloading digital content with unique identity recognition through a network. By the invention, when a user purchases digital content products from different web stores, the user is only required a unique identity (UID) for recognition so as to download the digital content products. In addition, when the digital content products are used, it is unnecessary for the user to remember different identities for respective web stores. In this way, this approach brings the user great convenience.

The invention achieves the above-identified object by providing a system for ordering and downloading digital content with unique identity recognition through a network. The system includes a user terminal, a web store, and a digital right management (DRM) server. The web store is used for providing a digital content product for purchase at the user terminal. The DRM server, which is capable of connecting to the web store, is used for providing a unique identity (UID) for the user terminal to apply for, and the digital content product for the user terminal to download. In addition, the DRM server performs UID recognition for the user terminal so as to allow the user terminal to download the digital content product from the DRM server.

The invention achieves the above-identified object by providing a method for ordering and downloading digital content with unique identity recognition through a network. The method is for a user to order a digital content product at a web store and download the digital content product from a digital right management (DRM), wherein the user is to download the digital content product by using a reader program which is to be installed by the user. The method includes the following steps. First, the reader program is installed, and the DRM server assigns a unique identity (UID) to the reader program. The user then connects to the web store by using either a web browser or the reader program to login onto the web store with an identity and to start a transaction by submitting a message indicating an order for a digital content product to the web store. Responsive to the message indicating the order for the digital content product, the web store sends an order message for the digital content product to the DRM server. After the DRM server receives the order message, the DRM server sends a download message to the web store. Next, the web store informs the user that the digital content product is ready to be downloaded by sending a notification message from to the user. The reader program is then invoked so as to enter a download mode and connect to the DRM server. The DRM server then performs UID recognition for the reader program. If the UID of the reader program is recognized to be invalid, the method ends. If the UID of the reader program is recognized to be valid, the reader program downloads the digital content product from the DRM server. When the reader program finishes downloading, the DRM server informs the web store of completion of the transaction.

### BRIEF DESCRIPTION OF THE DRAWINGS

Other objects, features, and advantages of the invention will become apparent from the following detailed description of the preferred but non-limiting embodiments. The description is made with reference to the accompanying drawings in which:

FIG. 1 (Prior Art) illustrates a user logging onto web stores through the Internet;

FIG. 2 shows a system for ordering and downloading digital content with unique identity recognition through a network according to a preferred embodiment of the invention;

FIG. 3 is a flowchart of a method for ordering and downloading digital content with unique identity recognition through a network according to a preferred embodiment of the invention; and

FIG. 4 illustrates the digital right management (DRM) server providing a UID for the user.

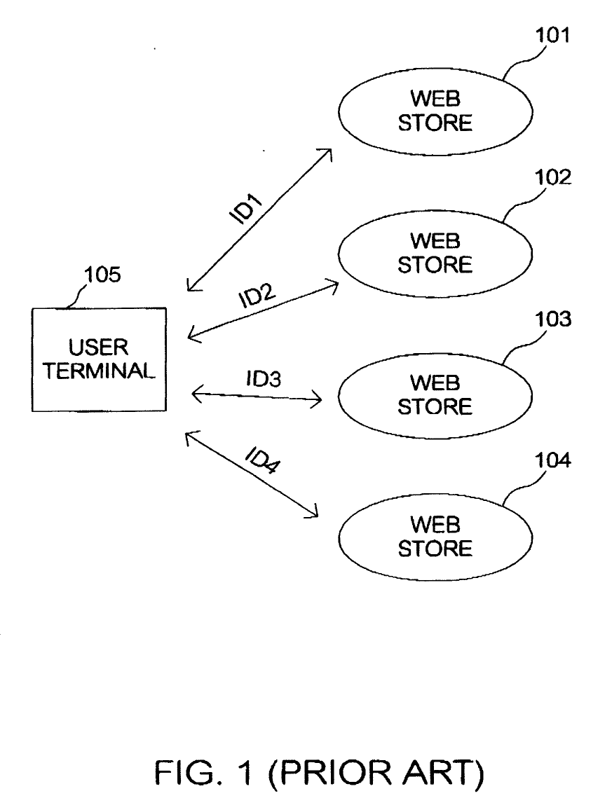

### DESCRIPTION OF THE PREFERRED EMBODIMENT

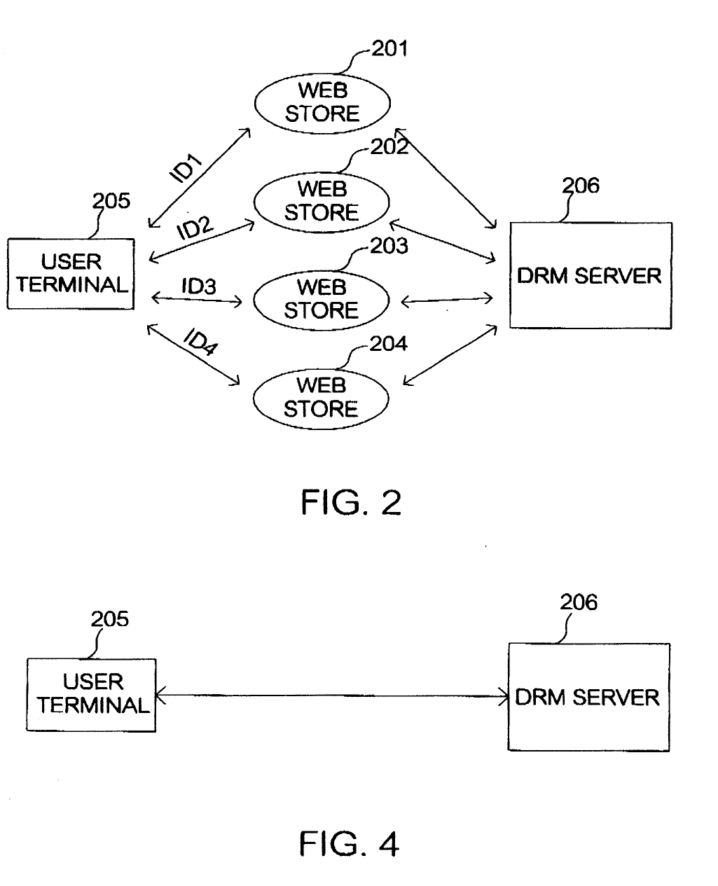

Referring to FIG. 2, it illustrates a system for ordering and downloading digital content with unique identity recognition in a network according to a preferred embodiment of the invention. In order to purchase and download digital content, a user has to obtain an identity from a web store. By using a user terminal 205 connected to the network such as the Internet, the user registers at web stores 201, 202, 203, and 204 respectively and then obtains identities ID1, ID2, ID3, and ID4 at the web stores respectively. User terminal 205 is a computing device such as a computer system or a personal digital assistant. As shown in FIG. 2, the user are logged onto web stores 201, 202, 203, and 204 by using the identities ID1, ID2, ID3, and ID4 respectively.

The system for ordering and downloading digital content with unique identity recognition includes a digital right management (DRM) server 206. DRM server 206, which is capable of connecting to the web stores, is employed to manage user information and control digital content. In addition, DRM server 206 provides a unique identity (UID) for the user terminal to apply for, and the digital content product for the user terminal to download. The digital content can be such as e-book, music (e.g. MP3 music), video, picture, or software. In FIG. 2, DRM server 206 is connected to web stores 201, 202, 203, and 204 respectively.

In addition, the system for ordering and downloading digital content with unique identity recognition includes a reader program. The reader program, which is installed in user terminal 205, is to order digital content and to employ downloaded digital content, for example, read an e-book, listen to an MP3 file, or use a software program.

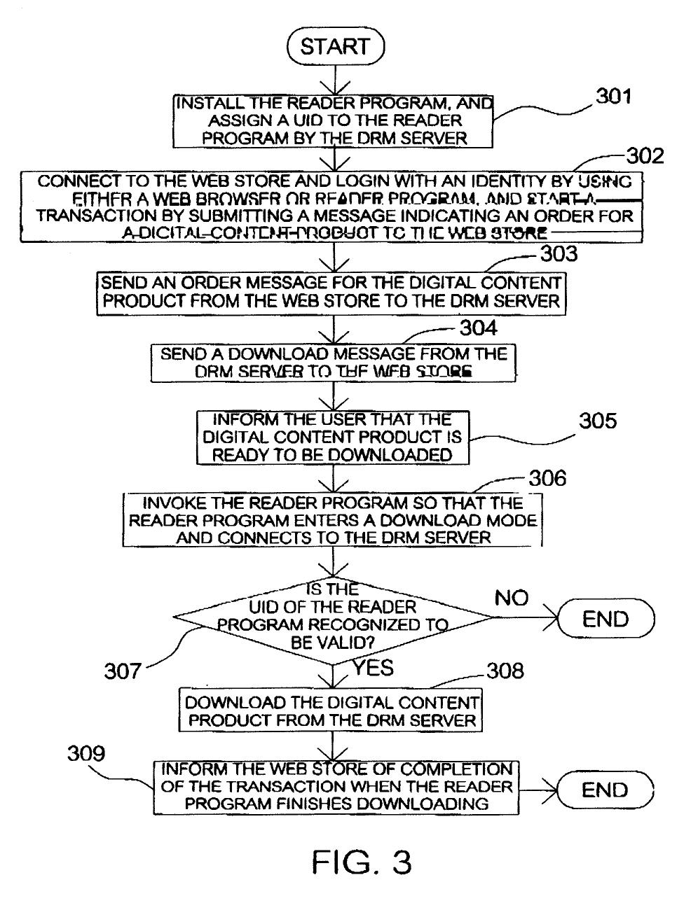

Referring to FIG. 3, it shows a flowchart illustrating of a method for ordering and downloading digital content with unique identity recognition according to a preferred embodiment of the invention. In FIG. 3, the method begins in step 310. In step 310, the user installs a reader program and DRM server 206 assigns a unique identity (UID) to the reader program, wherein the user can obtain the reader program by downloading the reader program from the web store or DRM server 206.

Referring to FIGS. 3 and 4, it shows that user terminal 205 is connecting to DRM server 206 and DRM server 206 sends the UID to user terminal 205. In FIG- 4, user terminal 205 connects to DRM server 206 after the reader program is installed in user terminal 205 as described in step 301. In addition, DRM server 206 assigns the UID to the reader program after the reader program registers at DRM server 206, wherein the reader program must register at DRM server 206. Moreover, this UID is different from the identities ID1, ID2, ID3, and ID4 obtained by registering at web stores respectively.

After step 310, the method proceeds to step 302. In step 302, the user utilizes either a browser or the reader program to connect to the Internet and login onto a web store by using one identity. In addition, once the user are logged onto the web store, the user can start a transaction of purchase of digital content by submitting a message indicating an order for digital content. For example, the user are logged onto web store 201 by using identity ID1, and is determined to purchase a digital content product, such as an e-book. Immediately, the user submits a message indicating an order for the e-book and made the payment by finishing a payment process. This payment process is according to the e-commerce payment mechanism provided by web store 201. For instance, a payment is made by using a credit card.

After submitting the message indicating the order for the e-book, in step 303, web store 201, responsive to this message, sends an order message for the e-book to DRM server 206. The order message is associated with the message indicating the order for the e-book from the user, and includes information about the e-book and the purchase of the e-book such as the serial number of the e-book, title, price, vendor (i.e. web store 201), and identity of the purchaser (i.e. ID1). Next, in step 304, on receiving the order message for the e-book, DRM server 206 enters a download mode for the user to download the e-book, and inform web store 201 that downloading of the e-book is ready to start by sending a download message to web store 201. Then, the method proceeds to step 305. In step 305, web store 201, responsive to the download message, sends a notification message to the user to inform the user that the e-book is ready to be downloaded. The notification message, such as a dynamic web page, is displayed on the browser or the reader program.

Following that, step 306 is performed. In step 306, if the user utilizes a browser in step 302, the reader program is invoked by the browser in response to the notification message in step 305. The reader program then enters a download mode and connects to DRM server 206. The method next proceeds to step 307. In step 307, DRM server 206 performs UID recognition for the reader program. If the UID of the reader program is recognized to be valid, the method proceeds to step 308. If not, it indicates that the UID of the reader program is recognized to be invalid or cannot be recognized, and the method thus ends. In step 308, DRM server 206 encrypts the e-book by using a key associated with the UID, and provides this encrypted version of the e-book for the reader program to download. After that, the method proceeds to step 309 where DRM server 206 informs web store 201 of completion of the transaction when the reader program finishes downloading.

Since the reader program has the UID associated with the user, after the user downloads the e-book, the user can use the reader program to read the e-book directly without entering identity ID1 assigned by web store 201

As disclosed above, the system and method for ordering and downloading digital content with unique identity recognition through a network has an advantage that the user who purchases a digital content product is required to open and use the downloaded digital content product with using only a UID. With the reader program associated with the UID, the user can open the digital content product directly and it is unnecessary to remember which identity associated with the digital content product. Thus, when the user have purchased many digital content products, it is unnecessary for the user to remember which of the identities obtained by different web stores is associated with the digital content product to be opened. In this way, the inconvenience of entering and remembering a lot of identities associated with different downloaded digital content products is reduced, and the user can use the digital content products more conveniently.

While the invention has been described by way of example and in terms of the, preferred embodiment, it is to be understood that the invention is not limited to the disclosed embodiment. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for ordering and downloading digital content with unique identity recognition through a network, for a user to order a digital content product from a web store and download the digital content product from a digital right management (DRM), wherein the user is to download the digital content product by using a reader program which is to be installed by the user, the method comprising the steps of:
(a) installing the reader program, and assigning a unique identity (UID) to the reader program by the DRM server;
(b) connecting to the web store by using a web browser and logging onto the web store by using an identity, and starting a transaction by submitting a message indicating an order for a digital content product to the web store;
(c) responsive to the message indicating the order for the digital content product, sending an order message for the digital content product from the web store to the DRM server;
(d) sending a download message from the DRM server to the web store;
(e) informing the user that the digital content product is ready to be downloaded by sending a notification message from the web store to the user;
(f) entering a download mode at the reader program and connecting to the DRM server, wherein the reader program is invoked by the browser responsive to the notification message;
(g) performing UID recognition for the reader program at the DRM server, and proceeding to step (h) if the UID of the reader program is recognized to be valid, and ending the method if the UID of the reader program UID is recognized to be invalid;
(h) downloading the digital content product from the DRM server; and
(i) informing the web store of completion of the transaction when the reader program finishes downloading.

2. A method according to claim 1, wherein the prompt message is a dynamic web page.

3. A method according to claim 1, wherein, before said step (h), the method further comprises:
encrpyting the digital content product at the DRM server by using a key associated with the UID.

4. A method for ordering and downloading digital content with unique identity recognition through a network, for a user to order a digital content product from a web store and download the digital content product from a digital right management (DRM), wherein the user is to download the digital content product by using a reader program which is to be installed by the user, the method comprising the steps of:
(a) installing the reader program, and assigning a unique identity (UID) to the reader program by the DRM server;
(b) connecting to the web store by using a web browser and logging onto the web store by using an identity, and starting a transaction by submitting a message indicating an order for a digital content product to the web store;
(c) responsive to the message indicating the order for the digital content product, sending an order message for the digital content product from the web store to the DRM server;
(d) sending a download message from the DRM server to the web store;
(e) informing the user that the digital content product is ready to be downloaded by sending a notification message from the web store to the user;
(f) entering a download mode at the reader program and connecting to the DRM server;
(g) performing UID recognition for the reader program at the DRM server, and proceeding to step (h) if the UID of the reader program is recognized to be valid, and ending the method if the UID of the reader program UID is recognized to be invalid;
(h) downloading the digital content product from the DRM server; and
(i) informing the web store of completion of the transaction when the reader program finishes downloading.

5. A method according to claim 4, wherein the prompt message is a dynamic web page.

6. A method according to claim 4, wherein, before said step (h), the method further comprises:
encrpyting the digital content product at the DRM server by using a key associated with the UID.

7. A system for ordering and downloading digital content with unique identity recognition through a network, comprising:
a user terminal;
a web store for providing a digital content product for purchase at the user terminal; and
a digital right management (DRM) server capable of connecting to the web store, for providing a unique identity (UID) for the user terminal to apply for, and the digital content product for the user terminal to download;
wherein the DRM server performs UID recognition for the user terminal so as to allow the user terminal to download the digital content product from the DRM server.

8. A system according to claim 7, wherein the user terminal comprises a reader program, and the reader program is operative to browse the web store, order the digital content product in the web store, download the digital content product from the DRM server, and use the digital content product.
